(19) United States
(12) Patent Application Publication
(10) Pub. No.: US 2018/0264611 A1
(43) Pub. Date: Sep. 20, 2018

(54) TOOL HOLDER

(71) Applicant: SAUER GmbH, Stipshausen (DE)

(72) Inventors: Gaston SCHWENK, Simmern (DE); Jens KETELAER, Wiesbaden (DE); Manuel PRAETORIUS, Rhaunen (DE)

(21) Appl. No.: 15/756,281

(22) PCT Filed: Aug. 11, 2016
(86) PCT No.: PCT/EP2016/069131

§ 371 Date: Feb. 28, 2018

(30) Foreign Application Priority Data
Aug. 31, 2015 (DE) 10 2015 216 596.5

(51) Int. Cl. B23Q 11/10; B23B 29/12; B23B 37/00

(52) U.S. Cl. CPC B23Q 11/1023; B23B 29/125; B23B 2260/108; B23B 2231/24; B23B 2250/12; B23B 37/00

(57) ABSTRACT

The present invention relates to a tool holder for accommodating a tool, having a housing, a transmitting element, movably arranged in the housing, for transmitting a movement to the tool accommodated at a first end portion of the tool holder, a fastening portion at a second end portion of the tool holder, located opposite the first end portion of the tool holder, for fastening the tool holder to a machine tool, and a coolant line portion for conducting coolant from the second end portion of the tool holder to the first end portion of the tool holder, wherein the coolant line portion has a first section extending through the transmitting element, wherein the first section is configured at least in part as a bore in the transmitting element.

The present invention relates to a tool holder for receiving a tool, comprising a housing, a transmitting element arranged in a movable manner in the housing for transmitting a movement to the tool accommodated in a first end portion of the tool holder, a fastening portion at a second tool holder end portion opposite the first end portion of the tool holder for fastening the tool holder to a machine tool, and a coolant line portion for conducting coolant from the second end portion of the tool holder to the first end portion of the tool holder.

### BACKGROUND OF THE INVENTION

The prior art is familiar with tool spindles for use in a machine tool, said tool spindles having a continuous inner tube for cooling and lubricating the tool while workpieces are processed, by means of which the coolant is conducted to the tool.

EP 1 480 783 B1 describes a machine tool comprising a spindle having a tool support for an exchangeable tool holder which during the operation of the machine tool is clamped in the tool support and which has a small coolant tube for accommodating a cooling lubricant, and further comprising a first channel which is arranged in the spindle interior and has an outlet opening that opens inside the tool support, wherein the small coolant tube engages in the outlet opening of the first channel while the tool holder is clamped, wherein the first channel comprises a continuous inner tube, the first end of which is connected to an aerosol source and the second end of which is designed for a precisely fitted connection to the small coolant tube.

In addition, tool holders for the ultrasonic processing of workpieces are known, wherein the tool holder is caused to vibrate by a piezo system.

EP 1 763 416 B1 describes a tool comprising a tool holder and a spindle nose, wherein the tool holder has a tool holder support for adaptation to the rotary spindle nose at a first end and a tool support at a second end, and comprising a tool head which can be inserted into the tool support, wherein the tool holder and the spindle nose form a vibration motor and the vibration motor causes the tool holder to vibrate via a piezo system and the piezo system comprises a first stationary coil and a second coil engaging at the tool holder at a distance from the first coil, wherein the second coil is connected to piezo actuators.

When a coolant tube is used in a vibrating tool holder, an end of the coolant tube is fixedly connected to the housing of the vibrating tool holder in the direction of the spindle. At the other end of the coolant tube in the direction of the tool, the tube must be appropriately sealed by means of a suitable sealing element. This sealing element is positioned close to the vibration node of the vibrating system to avoid stresses of the sealing element resulting from the continuous vibrational motion. However, in such a design the problem arises that the tube cross-section and the coolant flow rate thus achievable are too low to ensure optimum cooling of the tool. In addition, the vibration drive cannot be cooled sufficiently well either.

### SUMMARY OF THE INVENTION

An object of the present invention is therefore to provide a tool holder with optimized coolant feedthrough.

This object is achieved by a tool holder according to claim 1. The dependent claims refer to advantageous embodiments of the tool holder according to the invention.

The tool holder according to the invention for accommodating a tool comprises: a housing, a transmitting element, movably arranged in the housing, for transmitting a movement to the tool accommodated at a first end portion of the tool holder, a fastening portion at a second end portion of the tool holder that is disposed opposite the first end portion of the tool holder, for fastening the tool holder to a machine tool, and a coolant line portion for conducting coolant from the second end portion of the tool holder to the first end portion of the tool holder, wherein the coolant line portion has a first section extending through the transmitting element and wherein the first section is designed at least in part as a bore in the transmitting element.

The coolant line portion consists of the tool holder parts which come into contact with the coolant. When the coolant flows directly through the bore in the movable part of the tool holder instead of through a thin-walled separate tube (which can easily be damaged e.g. in the assembly) conducted through the bore, this increases the stability of the design. For example, the transmitting element can be caused to vibrate and can transmit this vibration to the tool. The housing and the fastening portion of the tool holder do not co-vibrate in this case. On its way to the tool, the coolant is therefore conducted through a non-vibrating portion and through a vibrating portion of the tool holder. Due to the design according to the invention, a double-walled coolant feedthrough can be dispensed with, and therefore a larger diameter can be used to conduct the coolant to the tool, as a result of which the volume flow of the coolant conducted in the direction of the tool can be increased. Furthermore, the pressure by means of which the coolant is conducted through the coolant line portion can be increased on account of the increased wall thickness of the coolant channel and the resulting increased pressure resistance of the design. It is thus possible to better cool the tool and portions of the tool holder in the vicinity of the bore. In the final analysis, a higher precision is achieved in the processing of the workpiece.

The coolant line portion preferably has a second section extending through the fastening portion, wherein the first section and the second section are arranged so as to be movable against each other.

The advantage is that a movement of the transmitting portion, e.g. a vibration, in relation to other parts of the tool holder can be absorbed by a corresponding movement of the first section of the coolant line portion in relation to the second section. The coolant line portion can also consist of three or more sections which are movable in relation to one another.

At an end facing the second section, the first section preferably has a first connecting portion for connection to the second section and, at an end facing the first section, the second section has a second connecting portion for connection to the first section, wherein the first connecting portion and the second connecting portion are fitted into each other.

Such a design of the connection of the two sections of the coolant line portion, which can be moved against each other, has the advantage that the two connecting portions always overlap even when parts of the tool holder move, thus ensuring that there is a continuous coolant channel in the tool holder.

The first connecting portion is preferably designed as a hollow stud and arranged on the first section of the coolant line portion in such a way that the bore in the transmitting element is continued through an interior of the hollow stud and the second connecting portion preferably surrounds the first connecting portion peripherally, for conducting the coolant from the second section into the first section.

The advantage is that the coolant can be conducted from the fixed and/or non-vibrating part of the tool holder into the movable and/or vibrating part of the tool holder without leaking into the interior of the tool holder outside the coolant line portion.

The tool holder preferably has a sealing element, arranged between the first connecting portion and the second connecting portion, for sealing to prevent coolant from escaping the coolant line portion.

The advantage is that no coolant can escape the coolant line portion even if the connecting portions are moved in relation to each other.

The sealing element is preferably designed as a plastics ring which is pressed against an outer wall of the first connecting portion.

Therefore, the connection between the first section and the second section of the coolant line portion can be reliably sealed.

The outer wall of the first connecting portion is preferably ground.

The advantage is that, when the first connecting portion is moved in relation to the second connecting portion surrounding the first one, the first connecting portion does not get stuck at the second connecting portion such that no mechanical stresses are produced which can damage the sealing element.

The tool holder preferably has an ultrasonic transducer, connected to the transmitting element, for generating an ultrasonic vibration for the tool, wherein the ultrasonic transducer, the transmitting element and the first section of the coolant line portion form a vibratory system in the housing, the coolant line portion is centrally arranged in the tool holder and the ultrasonic transducer peripherally surrounds, at least in part, the bore in the transmitting element for cooling the ultrasonic transducer by the coolant in the bore.

Such an arrangement of the coolant-carrying elements of the tool holder and of the ultrasonic transducer in the tool holder has the advantage that the coolant cannot only be used to cool the tool but also to cool the ultrasonic transducer. This is important in particular to prevent a heat-related change in the vibration parameters of the vibratory system and of the tool.

In the case of a tool holder having a vibratory system, the first connecting portion and second connecting portion must be sealed in the design according to the invention at the site of a maximum vibration amplitude. Therefore, it is all the more important for such a tool holder that the surface of the first connecting portion is smoothed by grinding to avoid the abrasion of the sealant.

The bore in the transmitting element is preferably designed in such a way that the coolant passes through the transmitting element using a flow cross-section of at least 4.9 mm² and/or at a pressure of at least 60 bar.

For example, the bore can have a diameter of 2.5 mm. Since an additional coolant tube can be dispensed with in the bore with the design according to the invention, the entire width of the bore can be used for conducting coolant, which results in a 20% higher volume flow in relation to conventional coolant feedthrough system and in a coolant pressure of up to 80 bar in the tool holder. This raises above all the efficiency of the internal cooling and also that of the tool cooling.

The first section preferably has a branch and the transmitting portion has a plurality of openings of the coolant line portion so as to conduct the coolant from the branch to the openings.

The openings in the form of lateral outlets are suitable for draining the coolant in the case of tools, such as drills or milling cutters, which have no inner channel. Here, the piezo drive is also cooled by the coolant volume flow. In addition, the relatively higher pressure can also be used for the external cooling of the tool.

The tool holder preferably has a deflection element arranged on the tool holder in an exchangeable way to deflect the coolant leaving the openings in a direction of the tool accommodated at the tool holder.

The advantage is that a rapid adaptation of the coolant jet geometry to the employed tool is achieved in this way.

The tool holder preferably has a stabilizing element, arranged peripherally around the first connecting portion and the second connecting portion, for stabilizing a connection of the first section of the coolant line portion and of the second section of the coolant line portion.

The advantage is that the region of the tool holder in which the sections of the coolant line portion are connected becomes more stable.

The coolant is preferably air or water or an emulsion.

Air and water have the advantage that they can be provided in a cost-effective way. An emulsion has the advantage that its lubricating effect is high.

A machine tool according to the invention has the tool holder according to the invention, wherein the tool accommodated in the tool holder and parts of the tool holder that are arranged in the housing of the tool holder can be cooled along an axial direction of the tool holder during the processing of a workpiece by the coolant in the coolant portion.

### BRIEF DESCRIPTION OF THE DRAWINGS

FIG. 1 shows a sectional view of an embodiment of a tool holder according to the invention.

FIGS. 2A/B show a sectional view of a further embodiment of a tool holder according to the invention.

### DETAILED DESCRIPTION OF THE DRAWINGS AND OF THE PREFERRED EMBODIMENTS OF THE PRESENT INVENTION

The present invention is described and explained in detail below by means of embodiments and the exemplary drawings.

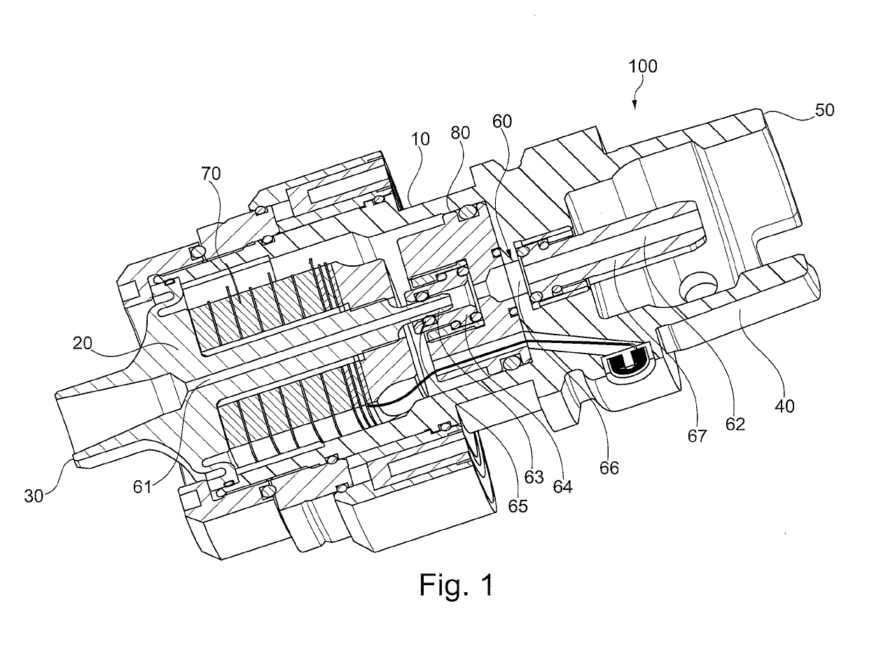

FIG. 1 shows a sectional view of an embodiment of a tool holder 100 according to the invention. The tool holder 100 is designed as a longitudinal element with a first end portion 30 and a second end portion 50, which is disposed opposite the first end portion 30. A tool 200 (not shown) can be accommodated at the first end portion 30. The second end portion 50 is provided with a fastening portion 40, by means of which the tool holder 100 can be fastened in an exchangeable way to a machine tool 300.

The tool holder 100 has a housing 10, in which a vibratory system is arranged, which has an ultrasonic transducer 70 and a transmitting element 20. The ultrasonic transducer 70 has stacked disk-like piezo elements which are excited by a generator (not shown) to a mechanical ultrasonic vibration. This vibration is transmitted by the mechanical coupling of the ultrasonic transducer 70 with the transmitting element 20 to the transmitting element 20 and then to the tool 200.

In order to cool and lubricate the tool when a workpiece is processed, the tool holder 100 has a coolant line portion 60, through which coolant is conducted from an opening of the coolant line portion 60 in the area of the fastening portion 40 through the tool holder 100 to an opening of the coolant line portion 60 in the area of the transmitting portion 20 and leaves it under pressure.

A first section 61 of the coolant line portion 60 is designed as a bore in the transmitting element 20, and a first connecting portion 63 in the form of a hollow stud adjoins said bore. The hollow stud 63 is peripherally surrounded by a second connecting portion 64, which can be designed as a tube portion. For this purpose, the second connecting portion 64 has an inner diameter which is only a little larger than the outer diameter of the hollow stud 63. The opening of the hollow stud 63 is positioned inside the second connecting portion 64 at a distance from an opening of the connecting portion 64.

The cavity in the second connecting portion 64 is part of a second section 62 of the coolant line portion 60, which borders on the first section 61 of the coolant line portion 60. The cavity in the second connecting portion 64 can be continued through a channel in the transition portion 66 of the coolant line portion 60. The channel can be continued through a tube piece 67, which is connected to a device (not shown) which introduces coolant into the tool holder 100. In this embodiment, the channel in the transition portion 66 and the tube piece 67 are also part of the second section 62 of the coolant line portion 60. Coolant can thus be conducted from the second end portion 50 of the tool holder 100 through the entire length of the coolant line portion 60 to the tool 200 at the first end portion 30 of the tool holder 100.

In the case of an ultrasonic vibration of the vibratory system, the parts of the tool holder 100 that vibrate are those forming the first section 61 of the coolant line portion 60, i.e. the transmitting portion 20 and the hollow stud 63. The parts of the tool holder 100, which form the second section 62 of the coolant line portion 60, do not vibrate in this case. The hollow stud 63 thus vibrates in the second (non-vibrating) connecting portion 64. In order that the hollow stud 63 and the second connecting portion 64 do not come in direct mechanical contact in this case, the stud wall is ground and a sealing element 65 in the form of an O-ring is pressed on the hollow stud 63 in the annular space between hollow stud 63 and second connecting element 64. The sealing ring 65 thus provides a small minimum distance between the hollow stud 63 and the second connecting portion 64 and seals the connection between the first section 61 and the second section 62 of the coolant line portion 60 against the leakage of coolant from the coolant line portion 60.

The coolant flows directly in the bore of the transmitting portion 20. As a result, the entire diameter of the bore of e.g. 2.5 mm, i.e. a cross-sectional surface area of e.g. 4.9 mm², can be used for conducting the coolant. The wall formed by the transmitting element 20 around the bore is relatively thick (thicker than the bore diameter). In addition, a stabilizing element 80 is arranged in the housing 10 around the second connecting portion 64 and around part of the transition portion 66. This serves to largely avoid cavities inside the housing 10, which are not part of the coolant line portion 60. As a result, the coolant can be conducted through the tool holder 100 at a high pressure of up to 80 bar.

The ultrasonic transducer 70 is arranged as a ring element around the bore in the transmitting portion 20 without a cavity being disposed between the bore and the ultrasonic transducer 70 in a radial direction. The coolant flowing through the transmitting portion 20 thus also provides for a cooling of the ultrasonic transducer 70 via the cooling of the wall around the bore and the direct mechanical contact of the transmitting portion 20 with the ultrasonic transducer 70.

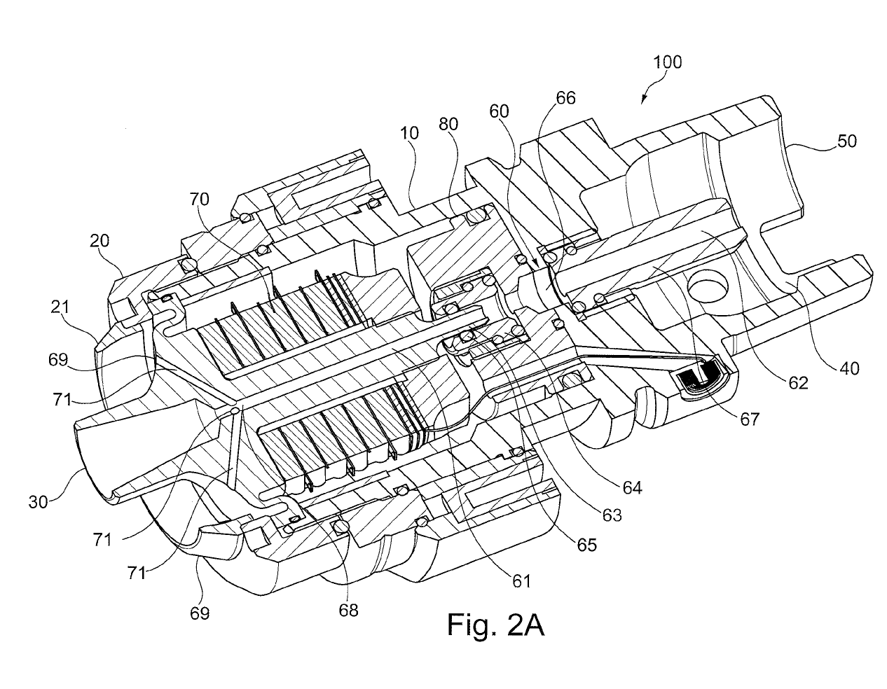

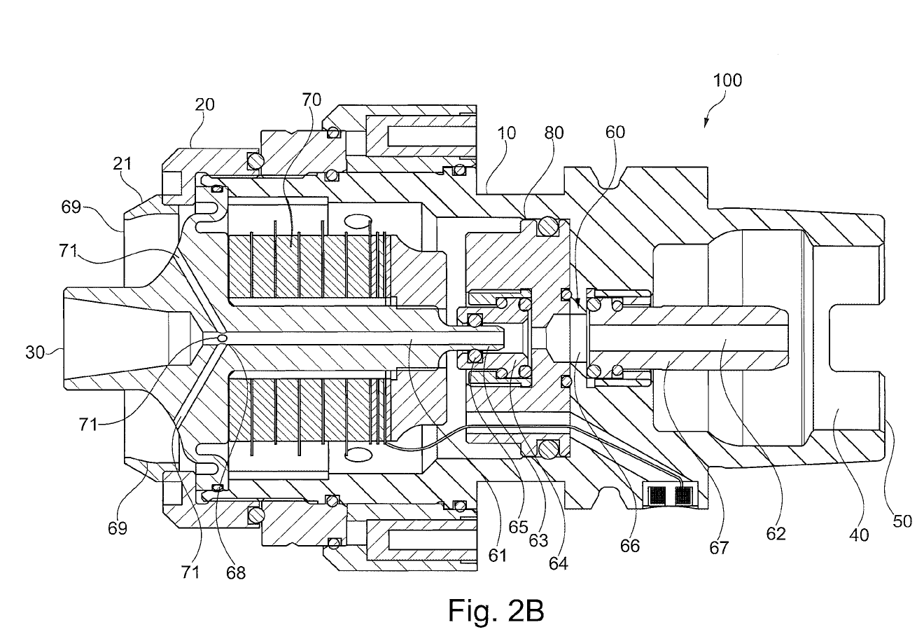

FIGS. 2A and 2B show a further embodiment of a tool holder 100 according to the invention as a sectional view from two different perspectives, which differs from the embodiment in FIG. 1 in that the bore in the transition portion 20 has a branch 68, such that the coolant is conducted to a plurality off openings 69, which are disposed in the transmitting portion 20 next to the tool 200. This is of significance when tools 200 are used which have no inner coolant channel, such as drills or milling cutters. In this case, the coolant cannot be conducted through a single opening of the coolant line portion 60 and further through the tool 200 to the tool tip, as illustrated in FIG. 1. In the embodiment illustrated in FIG. 2, the coolant is instead conducted from the branch 68 to the openings 69 in a plurality of channels 71 (e.g. in three channels 71 as shown in FIGS. 2A/B), which can be arranged around the tool 200.

This is where the coolant is conducted by means of a deflection element 21 at the tool holder 100 around the tool 200 to the tool tip. The deflection element 21 can be mounted on the tool holder 100 in an exchangeable way. In this way, on the one hand, the ultrasonic transducer 70 is additionally cooled on the side facing the tool 200 and, on the other hand, the outer side of the tool is also cooled.

The present invention is not limited to the above described embodiments. On the contrary, individual aspects and/or individual features of the above described embodiments can be combined to provide further embodiments of the present invention.

### LIST OF REFERENCE SIGNS

100 tool holder
10 housing
20 transmitting element
21 deflection element
30 first end portion
40 fastening portion
50 second end portion
60 coolant line portion
61 first section
62 second section
63 first connecting portion
64 second connecting portion
65 sealing element
66 transmitting portion
67 tube piece
68 branch
69 opening
71 channel
70 ultrasonic transducer
80 stabilizing element
200 tool
300 machine tool

1. A tool holder for accommodating a tool comprising a housing,
a transmitting element, movably arranged in the housing, the transmitting element configured to transmit a movement to the tool, which is accommodated at a first end portion of the tool holder,
a fastening portion at a second end portion of the tool holder, located opposite the first end portion of the tool holder, the fastening portion configured to fasten the tool holder to a machine tool, and
a coolant line portion configured to conduct coolant from the from the second end portion of the tool holder to the first end portion of the tool holder, characterized in that
the coolant line portion comprises a first section, which extends through the transmitting element, wherein the first section is configured, at least in part, as a bore in the transmitting element.

2. The tool holder according to claim 1, wherein
the coolant line portion comprises a second section which extends through the fastening portion, wherein
the first section and the second section are movably arranged against one another.

3. The tool holder according to claim 2, wherein
the first section comprises a first connecting portion at an end facing the second section for connection to the second section and
the second section comprises a second connecting portion at an end facing the first section for connection to the first section, wherein
the first connecting portion and the second connecting portion are joined into each other.

4. The tool holder according to claim 3, wherein
the first connecting portion is designed as a hollow stud and is arranged on the first section of the coolant line portion in such a way that the bore in the transmitting element is continued through an interior space of the hollow stud, and
the second connecting portion peripherally surrounds the first connecting portion for conducting the coolant from the second section into the first section.

5. The tool holder according to claim 3, further comprising
a sealing element, arranged between the first connecting portion and the second connecting portion, the sealing element configured to seal to prevent coolant from leaving the coolant line portion.

6. The tool holder according to claim 5, wherein
the sealing element is designed as a ring made of a plastic material, which is pressed on an outer wall of the first connecting portion.

7. The tool holder according to claim 6, wherein
the outer wall of the first connecting portion is ground.

8. The tool holder according to claim 1, further comprising
an ultrasonic transducer connected to the transmitting element, the ultrasonic transducer configured to produce an ultrasonic vibration for the tool, wherein
the ultrasonic transducer, the transmitting element, and the first section of the coolant line portion form a vibratory system in the housing,
the coolant line portion is arranged centrally in the tool holder, and
the ultrasonic transducer peripherally surrounds, at least in part, the bore in the transmitting element for cooling the ultrasonic transducer by the coolant in the bore.

9. The tool holder according to claim 1, wherein
the bore in the transmitting element is configured in such a way that the coolant passes through the transmitting element while using a flow cross-section of at least 4.9 mm² and/or at a pressure of at least 60 bar.

10. The tool holder according to claim 1, wherein
the first section has a branch, and
the transmitting element has a plurality of openings of the coolant line portion in such a way that the coolant is conducted from the branch to the openings.

11. The tool holder according to claim 10, further comprising
a deflector element, which is arranged in an exchangeable manner on the tool holder, the deflector element configured to deflect the coolant leaving the openings in a direction of the tool accommodated at the tool holder.

12. The tool holder according to claim 1, comprising
a stabilizing element, peripherally arranged around the first connecting portion and the second connecting portion, the stabilizing element configured to stabilize a connection between the first section of the coolant line portion and the second section of the coolant line portion.

13. The tool holder according to claim 1, wherein
the coolant is air or water or an emulsion.

14. The tool holder of claim 1, wherein the tool holder is incorporated in a machine tool,
wherein
the tool, which is accommodated in the tool holder, and parts of the tool holder, which are arranged in the housing of the tool holder, can be cooled by the coolant in the coolant line portion along an axial direction of the tool holder while a workpiece is processed.
